(19) United States
(12) Patent Application Publication
(10) Pub. No.: US 2010/0039091 A1
(43) Pub. Date: Feb. 18, 2010

(54) START-UP CIRCUIT FOR BANDGAP CIRCUIT

(76) Inventor: Ian Vidler, Livingston (GB)

Correspondence Address: REED SMITH LLP, P.O. BOX 488, PITTSBURGH, PA, 15230-0488, US

(21) Appl. No.: 12/444,351

(22) PCT Filed: Sep. 10, 2007
(86) PCT No.: PCT/GB07/03412

§ 371 Date: May 29, 2009

(30) Foreign Application Priority Data
Oct. 4, 2006 (GB) 0619623.2

(51) Int. Cl. G05F 3/30

(52) U.S. Cl. 323/313

(57) ABSTRACT

A start-up circuit is provided for a bandgap circuit, the bandgap circuit having at least one bandgap diode. The start-up circuit comprises a comparator for providing a start-up voltage for the bandgap circuit. The comparator is connected to receive a first reference voltage at a first input terminal, the output of the comparator being connected in a feedback loop to its second input terminal. A reference voltage circuit is provided for generating the first reference voltage for the first input terminal of the comparator. The reference voltage circuit comprises a start-up circuit diode that is matched with the at least one bandgap diode in the bandgap circuit. As such, any temperature and/or process variations in the bandgap diode are matched by the start-up circuit diode, thereby providing an accurate and reliable reference voltage, and hence start-up voltage for the bandgap circuit.

### TECHNICAL FIELD OF THE INVENTION

This invention relates to a start-up circuit for a bandgap circuit, and in particular to a start-up circuit for a low-voltage bandgap circuit used in an ultra-wideband apparatus.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 per cent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The basic timing structure of a UWB system is a superframe. A superframe consists of 256 medium access slots (MAS), where each MAS has a defined duration, for example 256 μs. Each superframe starts with a Beacon Period, which lasts one or more contiguous MASs. The start of the first MAS in the beacon period is known as the “beacon period start”.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

A bandgap circuit is a voltage reference circuit widely used in integrated circuits, including integrated circuits used in ultra-wideband apparatus.

Conventional bandgap circuits produce a reference voltage of around 1.25 V. However, a paper by H Banba et al (“A CMOS bandgap reference circuit with sub 1 V operation”, IEEE Journal of Solid State Circuits, vol. 34, May 1999, pages 670-674) introduced a bandgap circuit which operates below 1 V. Such bandgap circuits are preferably required for 0.13 μm CMOS process technology and below.

These new low-voltage bandgap circuits create additional problems. In particular, such circuits have more than one convergence point, such that different outputs are produced (this aspect will be described in greater detail with reference to FIGS. 2 and 4 below). A different output from that which is desired will cause a malfunction in the circuits relying on the bandgap circuit for a voltage reference. In order to reliably operate the low-voltage bandgap circuit such that the desired voltage is output, a different form of start-up circuit is required.

The paper by Banba et al describes a digital reset solution for start-up. This requires an external digital reset pulse at power up. This solution is non-optimal since it places a large current spike on the supply (caused by the main PMOS devices being switched hard on at start-up for convergence).

Other known start-up circuits suffer from temperature and/or process variations, or from operational amplifier offset mismatches. For example, FIG. 2 shows a conventional start-up circuit comprising a potential divider circuit comprising resistors 3, 5 and a source follower in the form of an NMOS transistor 7. Point A is connected to the node requiring start-up. During start-up, when the voltage at point A is below the voltage at point C, current will flow through the NMOS transistor 7. During normal operation, when the voltage at point A is above the voltage at point C, current will not flow through the NMOS transistor 7. Although this circuit is suitable for use at a zero convergence point, the circuit is not suitable for use with the bandgap at the near diode threshold, since this point will change due to temperature and process variations.

It is an aim of the present invention to provide a reliable start-up circuit for a bandgap circuit that is tolerant of temperature and/or process variations, and/or operational amplifier offset mismatches.

### STATEMENT OF INVENTION

According to the present invention, there is provided a start-up circuit for a bandgap circuit, the bandgap circuit comprising at least one bandgap diode. The start-up circuit comprises a comparator for providing a start-up voltage for the bandgap circuit, the comparator connected to receive a first reference voltage at a first input terminal, the output of the comparator connected in a feedback loop to its second input terminal. The start-up circuit also comprises a reference voltage circuit for generating the first reference voltage for the first input terminal of the comparator, wherein the reference voltage circuit comprises a start-up circuit diode, the start-up circuit diode being matched with the at least one bandgap diode in the bandgap circuit.

According to another aspect of the present invention, there is provided a method of providing a start-up voltage for a bandgap circuit, the bandgap circuit comprising at least one bandgap diode. The method comprises the steps of providing a comparator for generating the start-up voltage for the bandgap circuit, the comparator connected to receive a first reference voltage at a first input terminal, the output of the comparator connected in a feedback loop to its second input terminal, and providing a reference voltage circuit for generating the first reference voltage for the first input terminal of the comparator, wherein the reference voltage circuit comprises a start-up circuit diode, the start-up circuit diode being matched with the at least one bandgap diode in the bandgap circuit.

Since the invention uses a substantially identical diode in the start-up circuit to the bandgap diode to generate a reference voltage to determine whether to turn the start-up circuit on or off, the reference voltage so created tracks with the bandgap as the temperature changes. Thus, the invention has the advantage of being less susceptible to temperature and/or process variations.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

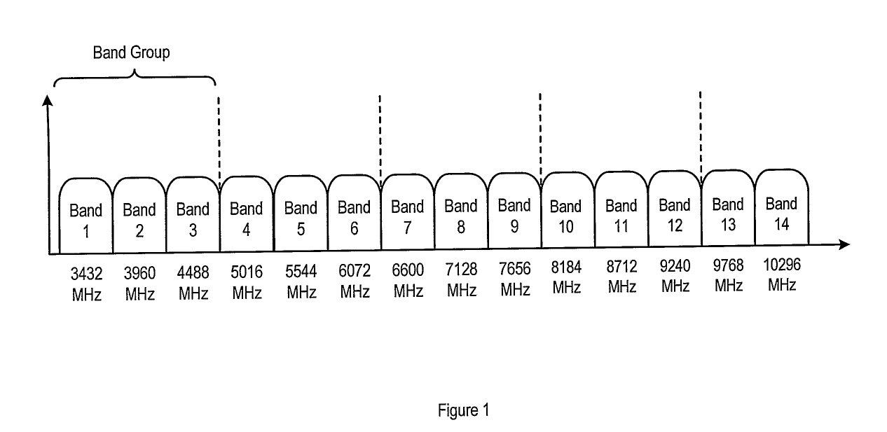

FIG. 2 shows a conventional start-up circuit;

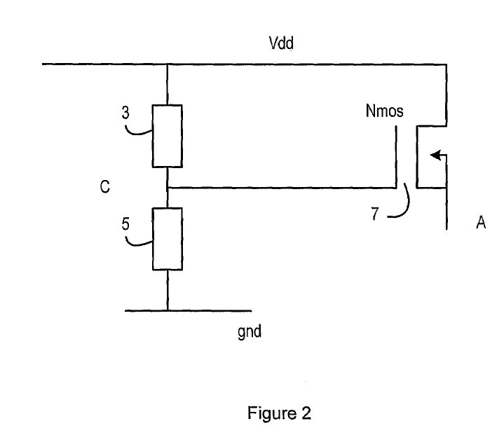

FIG. 3 is a diagram of the bandgap circuit and the start-up circuit according to the present invention; and

FIG. 4 is a graph showing the variation of voltage with the current at nodes A and B of FIG. 3.

### DETAILED DESCRIPTION OF A PREFERRED EMBODIMENT OF THE PRESENT INVENTION

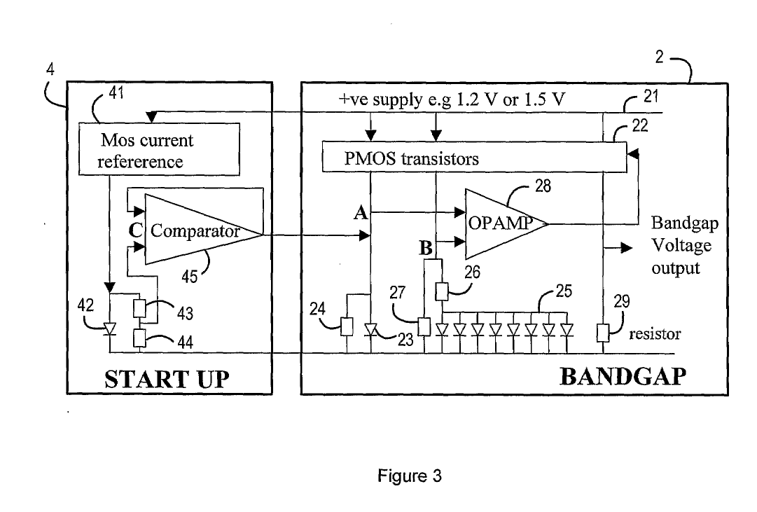

FIG. 3 is a diagram of the bandgap circuit 2 and the start-up circuit 4 according to the present invention.

The bandgap circuit 2 comprises a positive supply voltage 21, for example a 1.2 V or a 1.5 V supply voltage, and PMOS transistors 22.

The bandgap circuit further comprises a first bandgap diode 23, connected in parallel with a resistor 24. A sample voltage A is taken across this resistor 24.

The bandgap circuit further comprises a plurality of bandgap diodes 25 connected in series with a resistor 26. This combination is further connected in parallel with a resistor 27. A sample voltage B is taken across this resistor 27.

Sample voltages A and B are input to an operational amplifier 28, the output of the operational amplifier 28 being connected to the PMOS transistors 22. A further resistor 29 is connected between the PMOS transistors 22 and ground, and creates the output bandgap voltage.

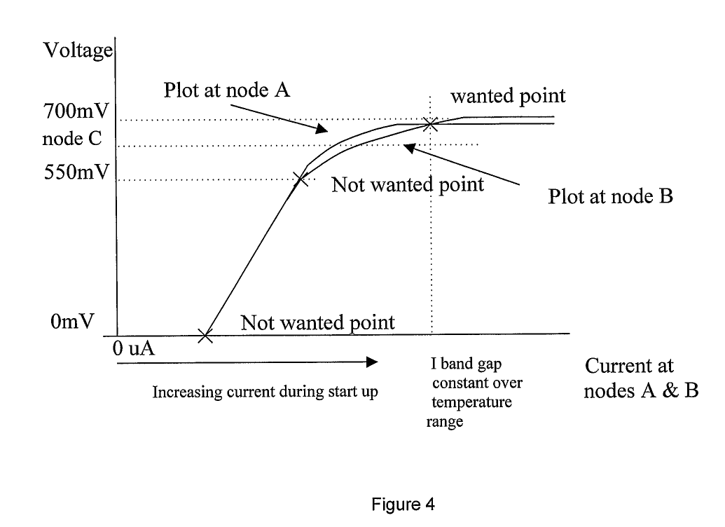

The bandgap circuit 2 creates an accurate reference voltage. However, as mentioned above, the bandgap circuit 2 can experience problems during start-up, whereby the circuit cannot generate any initial voltage by itself. This is illustrated with reference to FIG. 4, which is a graph showing how the voltages A and B vary with current.

As can be seen in FIG. 4, there are three convergence points where the inputs A and B of the operational amplifier 28 are equal. The first of these is at 0 V. The second is near a diode threshold voltage (for example approximately 550 mV), with the third being above the diode threshold voltage (for example approximately 700 mV). Preferably, each of the diodes 23, 25 are of the same type, and have the same threshold voltage.

It is noted that the 700 mV voltage is the desired voltage input, since either of the other input voltages would result in a malfunction in any dependent circuits. Therefore, a start-up circuit is required to increase the current and hence the voltage to the desired level.

With reference to FIG. 3, the start-up circuit 4 according to the present invention comprises a MOS transistor constant current source 41, which provides a constant current to a diode 42. The diode 42 is connected in parallel with first and second resistors 43, 44, which are connected in series with one another. Resistor 43 is such that the voltage across the diode 42 is reduced by a nominal voltage, for example 50 mV. This is to account for hysteresis, as will be explained in greater detail below. The node connecting the first and second resistors 43, 44 is connected as an input to a comparator 45. The output of the comparator 45 provides the start-up reference voltage at node A, with a feedback loop being provided between the output of comparator 45 and the second input of comparator 45.

The comparator 45 compares the voltages at nodes A and C. If the voltage at node A is below the voltage at node C then the start-up is applied. If the voltage at node A is above the voltage at node C then the start-up is switched off

According to the present invention, the diode 42 is matched, i.e. made substantially identical, to the diode 23 and the plurality of diodes 25 in the bandgap circuit 2. Preferably the diode 42 is of the same type, and has the same forward voltage characteristic as the diode 23.

As such, rather than using an absolute voltage reference at node A to trigger when the bandgap circuit is turned on and off, the invention provides a reference voltage at node A which is matched to the bandgap diodes, and therefore provides an accurate and reliable reference. In other words, any temperature and/or process variations in the diodes of the bandgap circuit are reflected by similar temperature and/or process variations in the diode of the start-up circuit.

As such, the start-up circuit according to the invention has several advantages over the prior art. As explained above, a conventional start-up circuit will solve the problem at zero voltage but not at the near diode threshold. The problem is further complicated as the “near diode threshold” and “above diode threshold” points move up/down and further/nearer to each other dependant on temperature, process variations and mismatch. The worst case is at low temperature (for example below 0° C.) where the “near diode threshold” and the “above diode threshold” are closest together (approx. 100 mV at −40° C. in a 0.13 μm CMOS process).

In contrast, the present invention uses a substantially identical diode to the bandgap diode to generate a reference voltage to determine whether to turn the start-up circuit on or off. The reference voltage so created therefore tracks with the bandgap as the temperature changes.

It is noted that the specific voltages mentioned in the preferred embodiment are provided as examples only, and that the invention is equally applicable to circuits having similar circuitry or different voltages.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A start-up circuit for a bandgap circuit, the bandgap circuit comprising at least one bandgap diode, the start-up circuit comprising:
a comparator for providing a start-up voltage for the bandgap circuit, the comparator connected to receive a first reference voltage at a first input terminal, the output of the comparator connected in a feedback loop to its second input terminal;
a reference voltage circuit for generating the first reference voltage for the first input terminal of the comparator;
wherein the reference voltage circuit comprises a start-up circuit diode, an start-up circuit diode being matched with the at least one bandgap diode in the bandgap circuit.

2. The start-up circuit as claimed in claim 1, wherein the comparator is adapted to compare a voltage across the start-up circuit diode with a voltage across the bandgap diode; and
if the voltage across the start-up circuit diode is less than the voltage across the bandgap diode, provide a start-up voltage for starting the bandgap circuit.

3. The start-up circuit as claimed in claim 1, further comprising a constant current source for supplying current to the start-up circuit diode.

4. The start-up circuit as claimed in claim 1, wherein the start-up circuit diode is of the same type as the at least one bandgap diode in the bandgap circuit.

5. The start-up circuit as claimed in claim 1, wherein the start-up circuit diode has the same forward voltage characteristic as the at least one bandgap diode in the bandgap circuit.

6. The start-up circuit as claimed in claim 1, wherein the reference voltage circuit comprises a potential divider circuit comprising first and second resistors, a node connecting the first and second resistors providing the first reference voltage for the comparator, and wherein the start-up circuit diode is connected in parallel with the potential divider circuit.

7. A method of providing a start-up voltage for a bandgap circuit, the bandgap circuit comprising at least one bandgap diode, the method comprising the steps of:
providing a comparator for generating the start-up voltage for the bandgap circuit, the comparator connected to receive a first reference voltage at a first input terminal, an output of the comparator connected in a feedback loop to its second input terminal;
providing a reference voltage circuit for generating the first reference voltage for the first input terminal of the comparator;
wherein the reference voltage circuit comprises a start-up circuit diode, the start-up circuit diode being matched with the at least one bandgap diode in the bandgap circuit.

8. The method as claimed in claim 7, further comprising the step of comparing a voltage across the start-up circuit diode with a voltage across the bandgap diode; and
if the voltage across the start-up circuit diode is less than the voltage across the bandgap diode, generating the start-up voltage for starting the bandgap circuit.

9. The method as claimed in claim 7, wherein a constant current source is provided for supplying current to the start-up circuit diode.

10. The method as claimed in claim 7, wherein the start-up circuit diode is of the same type as the at least one bandgap diode in the bandgap circuit.

11. The method as claimed in claim 7, wherein the start-up circuit diode has the same forward voltage characteristic as the at least one bandgap diode in the bandgap circuit.

12. The method as claimed in claim 7, wherein the reference voltage circuit comprises a potential divider circuit comprising first and second resistors, the node connecting the first and second resistors providing the first reference voltage for the comparator, and wherein the start-up circuit diode is connected in parallel with the potential divider circuit.
